(19) United States
(12) Patent Application Publication
(10) Pub. No.: US 2024/0348577 A1
(43) Pub. Date: Oct. 17, 2024

(54) SYSTEM AND METHOD TO CREATE NON-EXPIRING URLS

(71) Applicant: Rakuten Mobile, Inc., Tokyo (JP)

(72) Inventors: Abhishek Pawankumar SHARMA, Tokyo (JP); Rajasi AHUJA, Tokyo (JP)

(21) Appl. No.: 18/250,980

(22) PCT Filed: Dec. 21, 2022
(86) PCT No.: PCT/US2022/053619

§ 371 Date: Apr. 28, 2023

(51) Int. Cl. H04L 61/45; H04L 67/02; H04L 67/10

(52) U.S. Cl. CPC H04L 61/45; H04L 67/02; H04L 67/10

(57) ABSTRACT

A method for creating non-expiring uniform resource locators (URLs), includes receiving, at a service catalog application, one or more registration POST application programming interface (API) calls; processing, by the service catalog application, each payload included with one or more registrations included in the POST API calls; storing, by the service catalog application, one or more artifacts corresponding to the one or more registrations to an object storage; generating, by the service catalog application, one or more custom URLs corresponding to an artifact bucket and an artifact file path; registering, by the service catalog application, the one or more custom URLs with a database; and sending, by the service catalog application, a response payload that includes the one or more custom URLs to a user.

### TECHNICAL FIELD

This description relates to a system to create non-expiring URLs and method of using the same.

### BACKGROUND

A cellular network is a telecommunication system of mobile devices (e.g., mobile phone devices) that communicate by radio waves through one or more local antenna at a cellular base station (e.g., cell tower). Cellular service is provided to coverage areas that are divided into small geographical areas called cells. Each cell is served by a separate low-power-multichannel transceiver and antenna at a cell tower. Mobile devices within a cell communicate through that cell's antenna on multiple frequencies and on separate frequency channels assigned by the base station from a pool of frequencies used by the cellular network.

A radio access network (RAN) is part of the telecommunication system and implements radio access technology. RANs reside between a device, such as a mobile phone, a computer, or remotely controlled machine, and provide connection with a core network (CN). Depending on the standard, mobile phones and other wireless connected devices are varyingly known as user equipment (UE), terminal equipment (TE), mobile station (MS), and the like.

### SUMMARY

In some embodiments, a method for creating non-expiring uniform resource locators (URLs), includes receiving, at a service catalog application, one or more registration POST application programming interface (API) calls; processing, by the service catalog application, each payload included with one or more registrations included in the POST API calls; storing, by the service catalog application, one or more artifacts corresponding to the one or more registrations to an object storage; generating, by the service catalog application, one or more custom URLs corresponding to an artifact bucket and an artifact file path; registering, by the service catalog application, the one or more custom URLs with a database; and sending, by the service catalog application, a response payload that includes the one or more custom URLs to a user.

In some embodiments, an apparatus, includes a processor; and a memory having instructions stored thereon that, in response to being executed by the processor, cause the processor to receive, at a service catalog application, one or more registration POST application programming interface (API) calls; process, by the service catalog application, each payload included with one or more registrations included in the POST API calls; store, by the service catalog application, one or more artifacts corresponding to the one or more registrations to an object storage; generate, by the service catalog application, one or more custom URLs corresponding to an artifact bucket and an artifact file path; register, by the service catalog application, the one or more custom URLs with a database; and send, by the service catalog application, a response payload that includes the one or more custom URLs to a user.

In some embodiments, a non-transitory computer readable medium having instructions stored thereon that, in response to being executed by a processor, cause the processor to receive, at a service catalog application, one or more registration POST application programming interface (API) calls; process, by the service catalog application, each payload included with one or more registrations included in the POST API calls; store, by the service catalog application, one or more artifacts corresponding to the one or more registrations to an object storage; generate, by the service catalog application, one or more custom URLs corresponding to an artifact bucket and an artifact file path; register, by the service catalog application, the one or more custom URLs with a database; and send, by the service catalog application, a response payload that includes the one or more custom URLs to a user.

### BRIEF DESCRIPTION OF THE DRAWINGS

Aspects of the present disclosure are understood from the following detailed description when read with the accompanying FIGS. 1n accordance with the standard practice in the industry, various features are not drawn to scale. In some embodiments, dimensions of the various features are arbitrarily increased or reduced for clarity of discussion.

FIG. 1 is a diagrammatic representation of a system for network slice design (NSD), in accordance with some embodiments.

FIG. 2 is a pictorial representation of a universal network service (NS) bundle, in accordance with some embodiments.

FIG. 3 is a data flow diagram of a method for policy onboarding unification, in accordance with some embodiments.

FIG. 4 is a data flow diagram of a method for creating non-expiring URLs, in accordance with some embodiments.

FIG. 5 is a data flow diagram of a method for accessing artifacts after expiration of a URL, in accordance with some embodiments.

FIG. 6 is a high-level functional block diagram of a processor-based system, in accordance with some embodiments.

### DETAILED DESCRIPTION

The following disclosure provides many different embodiments, or examples, for implementing distinctive features of the discussed subject matter. Examples of components, values, operations, materials, arrangements, or the like, are described below to simplify the embodiments. These are, of course, examples and are unintended to be limiting. Other components, values, operations, materials, arrangements, or the like, are contemplated. For example, the formation of a first feature over or on a second feature in the description that follows include embodiments in which the first and second features are formed in direct contact, and further include embodiments in which additional features are formed between the first and second features, such that the first and second features are unable to be in direct contact. In addition, some embodiments repeat reference numerals and/or letters in the numerous examples. This repetition is for the purpose of simplicity and clarity and is unintended to dictate a relationship between the various embodiments and/or configurations discussed.

Further, spatially relative terms, such as beneath, below, lower, above, upper and the like, are used herein for ease of description to describe one element or feature's relationship to another element(s) or feature(s) as illustrated in the FIGS. The spatially relative terms are intended to encompass different orientations of the device in use or operation in addition to the orientation depicted in the FIGS. The apparatus is otherwise oriented (rotated 90 degrees or at other orientations) and the spatially relative descriptors used herein likewise are interpreted accordingly.

A network service (NS) bundle is a bundle which includes technology services, configuration, manifest files, or other suitable services and files within the scope of some embodiments. The technology services are further subdivided into different network service descriptors (NSDs) and virtualized network function descriptors (VNFDs). The VNFDs are created with application bundles.

An application bundle file is a single, relocatable file that contains the artifacts to execute an application. An application bundle file is set to execute on an instance (or instantiation). Application files are relocated by moving the application bundle file. Except for system libraries, the application bundle file includes toolkit artifacts that are configured to be used to execute the application. The application does not access external toolkits when running on execution hosts (e.g., a smartphone used by a subscriber). Logically, an application bundle file includes parts of the application directory and the output directory, plus subdirectories from toolkits that contributed to the application. When an application bundle file is submitted for execution, the application bundle file is deployed to hosts on which the application runs. The application bundle file is then unbundled into a runtime application directory hierarchy that is similar to a compile-time hierarchy with the addition of any external toolkit entities. An application bundle file has an identifier that uniquely distinguishes one build of an application from another. When an application bundle file is submitted for execution, the identifier is used to check whether there is another instance of the same application already running, and in response to, the identifier shares the unbundled execution location. In this case, the same runtime application directory hierarchy is used for executions of a given application bundle file.

A network service descriptor (NSD) is a deployment template which includes information used by a network function virtualization orchestrator (NFVO) for life cycle management (LCM) of a network service (NS). An NS is a composition of network functions (NFs or applications) arranged as a set of functions with unspecified connectivity between the NFs or according to one or more forwarding graphs.

A network slice (a portion of the original network architecture that is divided or sliced into multiple logical and independent networks that are configured to effectively meet the various services requirements) is broken up into subnets where each subnet is dedicated to a domain (e.g., RAN, CN, transport domain, or end-to-end (E2E) that includes each). The transport domain references the telecommunication transmission facilities under which voice, data, and video communications are distributed between distant locations for use on a shared basis.

Within a subnet is one or more NSs or a bundle of NSs. Within a NS is one or more NFs or a bundle of NFs. An application bundle (e.g., a bundle containing the executable code of an application and its associated resources) is registered at an orchestrator bundle catalog (orchestration is the automated configuration, coordination, and management of computer systems and software). An onboarding service creates the bundle/package objects in a central inventory. The onboarding service sends a request to a policy manager for creating the policy descriptor files (without source element universally unique identifiers (UUIDs), which are 128-bit labels used for information in computer systems).

A policy manager determines the degree to which a service/device is allowed to do what the service/device is attempting/requesting (decision) and is then able to enforce the decision (enforcement). Some examples of policies include (1) is the customer allowed to use this service, (2) is there enough capacity to support this new service, (3) what happens to non-SLA (service level agreement) customers when a node approaches congestion, and (4) is the service request/activity a security threat?

The policy manager sends back a policy ID to the orchestrator and the orchestrator stores the policy ID with the package ID. A NF instantiation request is received from a user (e.g., instantiate a NF using a NFT (network function template) which includes a policy descriptor file with policy ID).

The instance is created in a central inventory. The orchestrator deploys the NF/application and sends notification to the policy manager for enabling the policies with respective policy IDs. The policy files are modified with pending (source element UUID or the like) information. After modifying the pending information, the descriptor is referenced as a policy template. Now the policy template is ready for activation by a user.

In some embodiments, a system and method for creating a non-expiring uniform resource locator (URL) is discussed. In some embodiments, a system and method for creating non-expiring URLs to extend the expiration time of presigned URLs from storage solutions is discussed. In some embodiments, a system and method for creating non-expiring URLs to extend expiration time of presigned URLs from on-demand cloud computing platform S3 storage solutions is discussed. For the purposes of discussion of the embodiments, S3 storage, S3 object storage, or S3 compliant object storage are used interchangeably. In some embodiments, S3 object storage, S3 storage, or S3 compliant object storage include all object storages that comply with S3 (application programming interfaces) APIs.

A URL, colloquially termed a web address, is a reference to a web resource that specifies the web resource location on a computer network and a mechanism for retrieving the web resource. A URL is a type of uniform resource identifier (URI), although the two terms are used interchangeably. URLs occur most commonly to reference web pages (hypertext transfer protocol (HTTP)) but are also used for file transfer (FTP), email (mailto), database access (java database connectivity (JDBC)), and many other applications. Most web browsers display the URL of a web page above the page in an address bar. A typical URL is configured to have the form http://www.example.com/index.html, which indicates a protocol (http), a hostname (www.example.com), and a file name (index.html).

A user who does not have full on-demand cloud computing platform credentials or permissions to access an S3 object is granted temporary access by using a presigned URL. A presigned URL is generated for an on-demand cloud computing platform user who has access to the object. The generated URL is then given to the authorized user. The presigned URL is entered in a browser or used by a program or HTML webpage. The credentials used by the presigned URL are those of the on-demand cloud computing platform user who generated the URL. A presigned URL remains valid for a limited period which is specified when the URL is generated.

An on-demand cloud computing platform service is a service that provides object storage through a web service interface. On-demand cloud computing platform S3 stores many types of objects, which allow uses like storage for Internet applications, backups, disaster recovery, data archives, data lakes for analytics, and hybrid cloud storage. On-demand cloud computing platform S3 manages data with an object storage architecture which provides scalability, high availability (HA), and low latency with high durability. The storage units of on-demand cloud computing platform S3 are objects which are organized into buckets. Each object is identified by a unique, user-assigned key. Buckets are managed using a console provided by on-demand cloud computing platform S3, programmatically with the on-demand cloud computing platform software development kit (SDK), the REST application programming interface (API), REST APIs from code, REST APIs from command line, or REST APIs from a browser. Objects are up to five terabytes in size. Requests are authorized using an access control list associated with each object bucket and support versioning which is disabled by default. The on-demand cloud computing platform authentication mechanism allows the creation of authenticated URLs, valid for a specified amount of time. Each item in a bucket further is served as a BitTorrent feed. The on-demand cloud computing platform S3 acts as a seed host for a torrent and any BitTorrent client can retrieve the file. This drastically reduces the bandwidth cost for the download of popular objects. A bucket is configured to save HTTP log information to a sibling bucket.

In some embodiments, a user registers a bundle/template/descriptor via a POST API call. In computing, POST is a request method supported by HTTP used by the World Wide Web (www). By design, the POST request method requests that a web server accept the data enclosed in the body of the request message, most likely for storing the body of the request message (e.g., the payload). A POST call is often used when uploading a file or when submitting a completed web form. As part of a POST request, an arbitrary amount of data of any type is sent to the server in the body of the request message. A header field in the POST request usually indicates the message body's Internet media type.

In some embodiments, a service catalog application processes the payload and stores artifacts to S3 object storage. In computing and telecommunications, the payload is the part of transmitted data that is the intended message. Headers and metadata are sent to enable payload delivery. Object storage (also known as object-based storage) is a computer data storage that manages data as objects, as opposed to other storage architectures like file systems which manage data as a file hierarchy, and block storage which manages data as blocks within sectors and tracks. Each object typically includes the data, a variable amount of metadata, and a globally unique identifier. Object storage is implemented at multiple levels, including the device level (object-storage device), the system level, and the interface level. In each case, object storage seeks to enable capabilities not addressed by other storage architectures, like interfaces that are directly programmable by the application, a namespace that spans multiple instances of physical hardware, and data-management functions like data replication and data distribution at object-level granularity. Object storage systems allow retention of massive amounts of unstructured data in which data is written once and read once (or many times). Object storage is used for purposes such as storing objects like videos and photos, or files in online collaboration services.

In other approaches, the service catalog requests an S3 presigned URL with an expiration time from an S3 function that generates presigned URLs with a limited expiration time. The service catalog then receives the S3 presigned URL with expiration time from the S3 function. The service catalog registers the S3 presigned URL with expiration time along with the payload artifacts in a database. Artifacts are separate documents constituting architecture. Artifacts provide descriptions of organization from different perspectives important for various actors. Artifacts are for improving communication between different actors.

In other approaches, a response payload with the S3 presigned URL links of the artifacts are sent to the user. In response to the expiration time having passed, the user who wants to download a file from the S3 object storage using the S3 presigned URL provided by the service catalog, receives a failure indication notifying the user the URL is invalid or expired.

The service Catalog generates S3 object storage presigned URLs for artifacts registered at the time of bundle/template/descriptor onboarding. The other approaches provide no solution to provide for presigned URLs that have unlimited expiration to ensure that the URLs are accessible throughout the duration for which files are stored on s3 object storage.

A URL configured with an expiration time creates problems. The S3 presigned URL is generated using access keys and secret keys and a URL with unlimited expiration is unable to be crated. Further, a S3 presigned URL with an unlimited expiration creates risk to exposure of the security keys. The S3 presigned URL is unable to be exposed for long durations as hackers are able to get access to a base of the system. Thus, in response to the creation of an extended expiration time, the S3 presigned URL is unable to be used because the presigned URLs generated by the S3 contain the presigned security header.

A user having access to the artifacts registered by the user at any time is useful. However, the security keys are unable to be shared with the user and in response to the S3 generated presigned URLs being given to user, a file path is also helpful so that the user is able to access the artifacts.

In some embodiments, a functionality is developed by which the URLs to access user files in the S3 object storage are configured to have an unlimited expiration time. At the same time, security keys are not exposed and the URL generated by the service catalog for each artifact does not contain a security header and hence there is no risk of exposing the system. Thus, a solution to providing S3 URLs with an unlimited expiration time is presented in some embodiments.

In some embodiments, a service catalog custom API URL for each artifact is created with the following formula:

{Service Catalog endpoint}/api/v1/storage/s3/{bucket name where file resides}/{path to the file}

An API is a way for two or more computer programs to communicate with each other. An API is a type of software interface, offering a service to other pieces of software. In contrast to a user interface, which connects a computer to a person, an application programming interface connects computers or pieces of software to each other. An API is not intended to be used directly by a person (the end user) other than a computer programmer who is incorporating it into the software. An API is often made up of different parts which act as tools or services that are available to the programmer. A program or a programmer that uses one of these parts is said to call that portion of the API. The calls that make up the API are also known as subroutines, methods, requests, or endpoints. An API specification describes these calls, meaning that the API specification explains how to use or implement the API. The term API is often used to refer to web APIs, which allow communication between computers that are joined by the internet. There are also APIs for programming languages, software libraries, computer operating systems, and computer hardware.

The above formula is the common API which is called when the user clicks/downloads on the service catalog generated URL to download a particular artifact. When this API is triggered, the API internally calls/redirects to the S3 function by providing the access key and security key to create a S3 presigned URL with limited expiration time of “X seconds”.

In some embodiments, a layer is created on top of the S3 presigned URL by which the URLs that the service catalog generates are accessed at any time and the service catalog generated URL does not have an expiration. In response to a user clicking (point and click are the actions of a user moving a pointer to a certain location on a screen (pointing) and then pressing a button on a mouse, usually the left button (click), or other pointing device) the service catalog generated URL, the user is redirected to a S3 presigned URL, generated on the spot, with limited expiration time. In this manner, in response to the user downloading the file, the redirected URL expires in “X seconds”. Thus, the security keys are not exposed for an unlimited time. Further, when the security keys change, the service catalog ensures that the new keys are now used to generate the redirected URLs. The URL generated by the service catalog, which is used by the user, remains the same. Thus, the user is unaffected.

In some embodiments, once the user is granted access to the service catalog, the user is able to access and download the artifacts. Access to the S3 object database is removed from the process. In this manner, the user has access to the user's artifacts and not the entire S3 object database where artifacts are stored by many other users possibly unrelated and unknown.

In some embodiments, a user registers a bundle/template/descriptor via a POST API call. The service catalog processes the payload and stores the artifacts to a S3 object storage. The service catalog then generates URLs for each artifact. The URL is a custom URL according to the formula:

{Service Catalog endpoint}/api/v1/storage/s3/{bucket name where file resides}/{path to the file}

The storage catalog then registers the custom generated URLs for artifacts in a database. The service catalog the sends a response payload with the custom generated URL links for each artifact to the user.

In some embodiments, in response to a user wanting to download a file from the S3 object storage after the expiration time has passed using the custom generated URL provided by the service catalog, (the custom URL is a catalog endpoint) the request goes to the service catalog and not to the S3 object storage. The service catalog then generates the S3 presigned URL for the bucket name and file path of the custom URL provided in a POST API call. The S3 function then returns the presigned URL for the bucket name and file path provided in the POST API call. The service catalog redirects the API and internally calls the presigned URL generated. Each artifact is then successfully downloaded for the user.

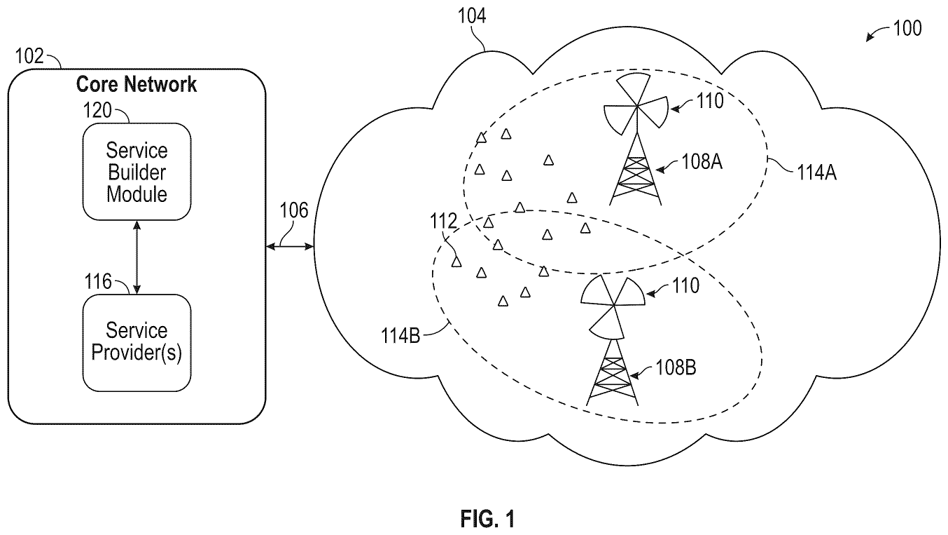

FIG. 1 is a diagrammatic representation of a system for network slice design (NSD) 100, in accordance with some embodiments.

NSD system 100 includes a CN 102 communicatively connected to RAN 104 through transport network 106, which is communicatively connected to base stations 108A and 108B (hereinafter base station 108), with antennas 110 that are wirelessly connected to UEs 112 located in geographic coverage cells 114A and 114B (hereinafter geographic coverage cells 114). CN 102 includes one or more service provider(s) 116, KPI servers 118, and service builder module 120.

CN 102 (further known as a backbone) is a part of a computer network which interconnects networks, providing a path for the exchange of information between different local area networks (LANs) or subnetworks. In some embodiments, CN 102 ties together diverse networks over wide geographic areas, in different buildings in a campus environment, or in the same building.

In some embodiments, RAN 104 is a global system for mobile communications (GSM) RAN, a GSM/EDGE RAN, a universal mobile telecommunications system (UMTS) RAN (UTRAN), an evolved UMTS terrestrial radio access network (E-UTRAN), open RAN (O-RAN), or cloud-RAN (C-RAN). RAN 104 resides between UE 112 (e.g., mobile phone, a computer, or any remotely controlled machine) and CN 102. In some embodiments, RAN 104 is a C-RAN for purposes of simplified representation and discussion. In some embodiments, base band units (BBU) replace the C-RAN.

In a hierarchical telecommunications network, transport network 106 of NSD system 100 includes the intermediate link(s) between CN 102 and RAN 104. The two main methods of mobile backhaul implementations are fiber-based backhaul and wireless point-to-point backhaul. Other methods, such as copper-based wireline, satellite communications and point-to-multipoint wireless technologies are being phased out as capacity and latency requirements become higher in 4G and 5G networks. Backhaul refers to the side of the network that communicates with the Internet. The connection between base station 108 and UE 112 begins with transport network 106 connected to CN 102. In some embodiments, transport network 106 includes wired, fiber optic, and wireless components. Wireless sections include using microwave bands, mesh, and edge network topologies that use high-capacity wireless channels to get packets to the microwave or fiber links.

In some embodiments, base stations 108 are lattice or self-supported towers, guyed towers, monopole towers, and concealed towers (e.g., towers designed to resemble trees, cacti, water towers, signs, light standards, and other types of structures). In some embodiments, base stations 108 are a cellular-enabled mobile device site where antennas and electronic communications equipment are placed, typically on a radio mast, tower, or other raised structure to create a cell (or adjacent cells) in a network. The raised structure typically supports antenna(s) 110 and one or more sets of transmitter/receivers (transceivers), digital signal processors, control electronics, a remote radio head (RRH), primary and backup electrical power sources, and sheltering. Base stations are known by other names such as base transceiver station, mobile phone mast, or cell tower. In some embodiments, other edge devices are configured to wirelessly communicate with UEs. The edge device provides an entry point into service provider CNs, such as CN 102. Examples include routers, routing switches, integrated access devices (IADs), multiplexers, and a variety of metropolitan area network (MAN) and wide area network (WAN) access devices.

In at least one embodiment, antenna(s) 110 are a sector antenna. In some embodiments, antenna(s) 110 are a type of directional microwave antenna with a sector-shaped radiation pattern. In some embodiments, the sector degrees of arc are 60°, 90°, or 120° designs with a few degrees extra to ensure overlap. Further, sector antennas are mounted in multiples when wider coverage or a full-circle coverage is desired. In some embodiments, antenna(s) 110 are a rectangular antenna, sometimes called a panel antenna or radio antenna, used to transmit and receive waves or data between mobile devices or other devices and a base station. In some embodiments, antenna(s) 110 are circular antennas. In some embodiments, antenna 110 operates at microwave or ultra-high frequency (UHF) frequencies (300 MHz to 3 GHz). In other examples, antenna(s) 110 are chosen for their size and directional properties. In some embodiments, the antenna(s) 110 are MIMO (multiple-input, multiple-output) antennas that send and receive greater than one data signal simultaneously over the same radio channel by exploiting multipath propagation.

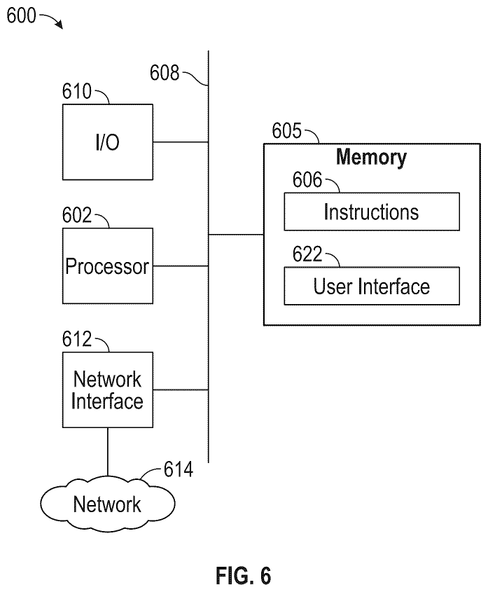

In some embodiments, UEs 112 are a computer or computing system. Additionally, or alternatively, UEs 112 have a liquid crystal display (LCD), light-emitting diode (LED) or organic light-emitting diode (OLED) screen interface, such as user interface (UI) 622 (FIG. 6), providing a touchscreen interface with digital buttons and keyboard or physical buttons along with a physical keyboard. In some embodiments, UE 112 connects to the Internet and interconnects with other devices. Additionally, or alternatively, UE 112 incorporates integrated cameras, the ability to place and receive voice and video telephone calls, video games, and Global Positioning System (GPS) capabilities. Additionally, or alternatively, UEs run operating systems (OS) that allow third-party apps specialized for capabilities to be installed and run. In some embodiments, UEs 112 are a computer (such as a tablet computer, netbook, digital media player, digital assistant, graphing calculator, handheld game console, handheld personal computer (PC), laptop, mobile Internet device (MID), personal digital assistant (PDA), pocket calculator, portable medial player, or ultra-mobile PC), a mobile phone (such as a camera phone, feature phone, smartphone, or phablet), a digital camera (such as a digital camcorder, or digital still camera (DSC), digital video camera (DVC), or front-facing camera), a pager, a personal navigation device (PND), a wearable computer (such as a calculator watch, smartwatch, head-mounted display, earphones, or biometric device), or a smart card.

In some embodiments, geographic coverage cells 114 include a shape and size. In some embodiments, geographic coverage cells 114 are a macro-cell (covering 1 Km-30 Km), a micro-cell (covering 200 m-2 Km), or a pico-cell (covering 4 m-200 m). In some embodiments, geographic coverage cells are circular, oval (FIG. 1), sector, or lobed in shape, but geographic coverage cells 114 are configured in most any shape or size. Geographic coverage cells 114 represent the geographic area antenna 110 and UEs 112 are configured to communicate.

Service provider(s) 116 or CSPs are businesses, vendors, customers, or organizations that sell bandwidth or network access to subscribers (utilizing UEs) by providing direct Internet backbone access to Internet service providers and usually access to network access points (NAPs). Service providers are sometimes referred to as backbone providers, Internet providers, or vendors. Service providers include telecommunications companies, data carriers, wireless communications providers, Internet service providers, and cable television operators offering high-speed Internet access.

In some embodiments, service builder module 120 is configured to allow a user to design one or more network slices. In some embodiments, the network slice design is GUI based. In some embodiments, operations include a user inputting basic information such as, network slice name, slice type, domains, and shared or non-shared slice selection. Other operations include defining a slice such as, NS profile parameters (holds the original requirement of communication-service-instance, such as latency, data-rate, and mobility-level) requested by a northbound interface (e.g., internal to the system or manually from a user) and conversion of NS profile parameters to slice profile parameters (holds the slice sub-net parameter info of different network domain slice subnet instances (NSSIs), such as RAN, transport network (TN), and CN NSSI).

In some embodiments, service builder module 120 is configured to unify policy onboarding, such as a network function/network services (NF)/(NS) package onboarding.

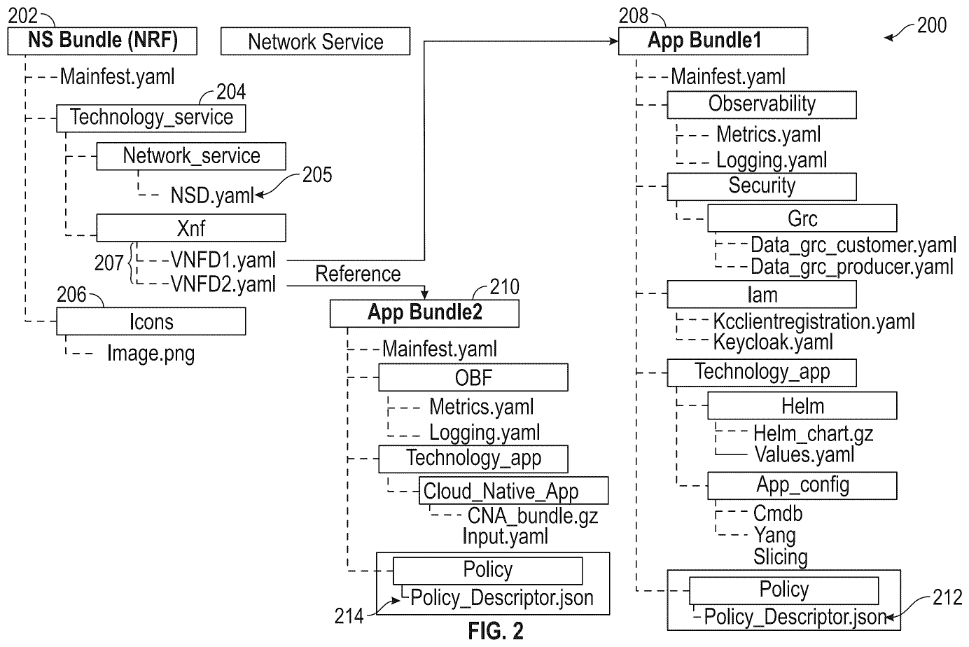

FIG. 2 is a pictorial representation of a universal NS bundle 200, in accordance with some embodiments.

For purposes of this discussion, application and network function are used interchangeably unless otherwise distinguished from one another.

In FIG. 2, a NS bundle 202 is an amalgamation of technology services 204 (and other services like icons 206) which is further subdivided into different NSDs 205 and VNFDs 207. In some embodiments, VNFDs 207 are created with application bundles 208, 210. In some embodiments, a policy descriptor 212 and 214 is part of application bundles 208 and 210. In some embodiments, policy descriptor files 212 and 214 are of a json format. In some embodiments, the policy bundle is part of a network service (NS)/(NF) network function bundle which includes other artifacts such as technology application images, metrics, configuration files, or other suitable files within the scope of some embodiments.

JSON is an open standard file format and data interchange format that uses human-readable text to store and transmit data objects consisting of attribute-value pairs and arrays (or other serializable values). JSON is a data format with diverse uses in electronic data interchange, including that of web applications with servers. JSON is a language-independent data format. JSON was derived from JavaScript, but many modern programming languages include code to generate and parse JSON-format data. JSON filenames use the extension json.

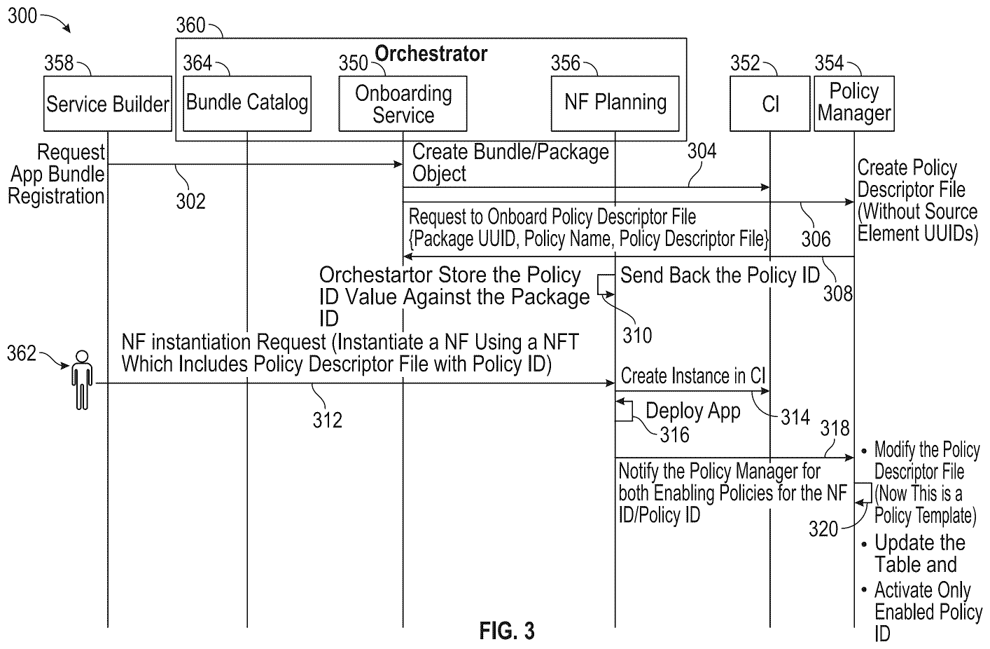

FIG. 3 is a data flow diagram of a method for policy onboarding unification 300, in accordance with some embodiments.

In some embodiments, method for policy onboarding unification 300 describes operations of unification of policy onboarding. While the operations of method for policy onboarding unification 300 are discussed and shown as having a particular order, each operation in method for policy onboarding unification 300 is configured to be performed in any order unless specifically called out otherwise. Method for policy onboarding unification 300 is implemented as a set of operations, such as operations 302 through 320.

At operation 302 of method for policy onboarding unification 300, service builder 358 registers an application bundle, such as application bundles 208 and 210, at bundle catalog 364 of orchestrator 360. In response to submission of the NF application, service builder tool 358 creates an application bundle and automatically registers the application bundle to bundle catalog 364 of orchestrator 360 via an application programming interface (API). A bundle is set of products that are offered under a single entitlement or license with no dedicated components. In bundle catalog 364, a bundle is modelled as a software product with setup relationships to the software products.

In some embodiments, service builder tool 358 is similar to service builder module 120 and includes references to NS bundles as the references are created by a slice manager. The slice manager is responsible for creating a network slice and NS subnet, whereas orchestrator 360 is responsible for creating NSs and NFs. Process flows from operation 302 to operation 304.

In some embodiments, method 300 describes a method for NS bundle creation and transportation. The slice manager takes care of a NS bundle for further execution of the bundle services to northbound systems (handle specific goals of a systematic operation). In some embodiments, method 300 describes a policy bundle which follows the same principle for bundle processing, with additional steps depicting how policy bundles are managed.

At operation 304 of method for policy onboarding unification 300, onboarding service 350 of orchestrator 360 creates bundle/package objects in the central inventory (CI) 352 and stores the bundle/package objects as inventory files. In some embodiments, an object is a variable, a data structure, a function, or a method. As regions of memory, the application bundle objects contain value and are referenced by identifiers. In some embodiments, an application bundle object is a combination of variables, functions, and data structures. In some embodiments, an application bundle object is a table or column, or an association between data and a database entity. Process flows from operation 304 to operation 306.

At operation 306 of method for policy onboarding unification 300, onboarding service 350 sends a request to policy manager 354 for creating the policy descriptor files (e.g., policy name, policy descriptor file (e.g., policy descriptor files 212 and 214), bundle/package UUID, but without source element UUIDs). In some embodiments, application bundle descriptor file is a JSON file (e.g., policy.descriptor.json) that describes the application bundle.

The descriptor file includes general information for the application bundle, as well as the modules that the application bundle wants to use or extend. The descriptor file serves as the glue between the remote application (e.g., with user 362) and the application at a CN, such as CN 102. In some embodiments, when an administrator for a cloud instance installs an application, a descriptor file is installed, which contains pointers to a NS. Process flows from operation 306 to operation 308.

At operation 308 of method for policy onboarding unification 300, policy manager 354 returns the policy ID, corresponding to a rule-based policy and an application bundle, to orchestrator 360. Process flows from operation 308 to operation 310.

At operation 310 of method for policy onboarding unification 300, life cycle management (LCM) or network function (NF) planning module 356 stores the policy ID with the package ID. Application LCM is the product lifecycle management (e.g., governance, development, and maintenance) of computer programs. Life cycle encompasses requirements management, software architecture, computer programming, software testing, software maintenance, change management, continuous integration, project management, and release management. Process flows from operation 310 to operation 312.

At operation 312 of method for policy onboarding unification 300, a NF instantiation request (e.g., instantiate a NF using a NFT which includes policy descriptor file with Policy ID) from user 362 is received. Process flows from operation 312 to operation 314.

At operation 314 of method for policy onboarding unification 300, a NF instance is created in CI 352. In some embodiments, a user is instantiating/installing a NF for which the policy bundle has been created. The context of NF instantiation is included to relate that this NF is for policy creation. Process flows from operation 314 to operation 316.

At operation 316 of method for policy onboarding unification 300, orchestrator 360 deploys the NF/application for user 362. Process flows from operation 316 to operation 318.

At operation 318 of method for policy onboarding unification 300, orchestrator 360 sends notification to policy manager 354 to enable rule-based policies with respective policy IDs. Thus, as user 362 is using the application, rule-based policies are in effect for the application. Process flows from operation 318 to operation 320.

At operation 320 of method for policy onboarding unification 300, policy manager 354 modifies the policy files with pending (e.g., source element UUID and the like) information. After filling the pending information, the policy descriptor file becomes a policy template. A policy template table is updated and the enable policy ID is activated. In some embodiments, the template refers to a valid working policy file (i.e., a template is a name ecosystem terminology). A policy template is crated once a created policy has parameters to implement the policy.

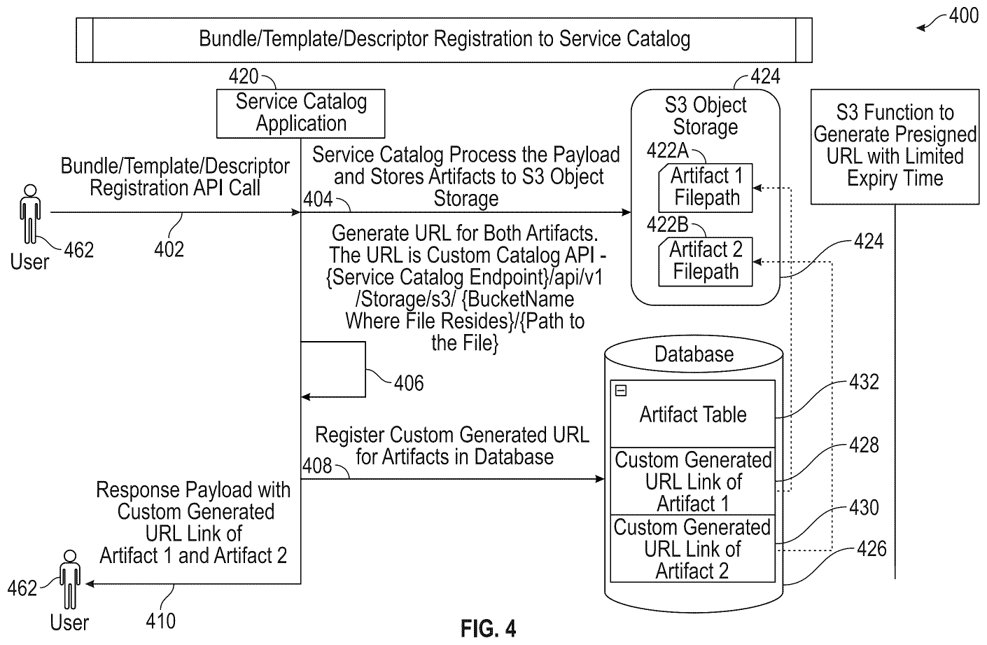

FIG. 4 is a data flow diagram of a method for creating non-expiring URLs 400, in accordance with some embodiments.

FIG. 4 is discussed to provide an understanding of the method for creating non-expiring URLs 400. In some embodiments, method for creating non-expiring URLs 400 is executed by processing circuitry 602 discussed below with respect to FIG. 6. In some embodiments, some, or all the operations of method for creating non-expiring URLs 400 are executed in accordance with instructions corresponding to instructions 606 discussed below with respect to FIG. 6.

Method for creating non-expiring URLs 400 includes operations 402-410, but the operations are not necessarily performed in the order shown. Operations are added, replaced, order changed, and/or eliminated as appropriate, in accordance with the spirit and scope of the embodiments. In some embodiments, one or more of the operations of method for creating non-expiring URLs 400 are repeated. In some embodiments, unless specifically stated otherwise, the operations of method for creating non-expiring URLs 400 are performed in order.

In operation 402 of method for creating non-expiring URLs 400, one or more bundles/templates/descriptors are registered via a POST API call initiated by user 462. In some embodiments, operation 402 is like operation 302 of method 300. The POST API call is sent to service catalog application 420. In some embodiments, service catalog application 420 is included in orchestrator 360. In some embodiments, service catalog application 420 is a standalone application operably connected to service builder 358. In some embodiments, user 462 registers the one or more bundles/templates/descriptors through a UI, such as UI 622 of FIG. 6. Process flows from operation 402 to operation 404.

In operation 404 of method for creating non-expiring URLs 400, service catalog 420 processes a payload of the one or more bundles/templates/descriptors and stores artifacts 422A and 422B to a S3 object storage 424. Process flows from operation 404 to operation 406.

In operation 406 of method for creating non-expiring URLs 400, service catalog application 420 generates a URL for the artifacts 422A and 422B. The URL is a custom catalog API with a template form of:

{ServiceCatalogendpoint}/api/v1/storage/s3/{bucketname where file resides}/{path to the file}

In some embodiments, {ServiceCatalogendpoint}/api/v1/storage/s3 describes the call, meaning that the call explains how to use or implement the call. An API is often made up of different parts which act as tools or services that are available to the programmer. A program or a programmer that uses one of these parts is said to call that portion of the API. The calls that make up the API are also known as subroutines, methods, requests, or endpoints.

In some embodiments, a S3 bucket used to store CloudTrail log files configured to have a name that conforms with naming standards. In some embodiments, S3 describes a bucket name as a series of one or more labels, separated by periods, that adhere to the following rules: (1) the bucket name is between 3 and 63 characters long, and contain lower-case characters, numbers, periods, and dashes, (2) each label in the bucket name starts with a lowercase letter or number, (3) the bucket name is unable to contain underscores, end with a dash, have consecutive periods, or use dashes adjacent to periods, and (4) the bucket name is unable to be formatted as an IP address.

In some embodiments, the path to file is a string of characters configured to be used to uniquely identify a location in a directory structure. The path to file is composed by following the directory tree hierarchy in which components, separated by a delimiting character, represent each directory. The delimiting character is commonly the slash (“/”), the backslash character (“\”), or colon (“:”), though some operating systems use a different delimiter. Paths are used extensively in computer science to represent the directory/file relationships common in modern operating systems and are essential in the construction of URLs. Resources are represented by either absolute or relative paths. Process flows from operation 406 to operation 408.

In operation 408 of method for creating non-expiring URLs 400, service catalog application 420 registers custom generated URLs for artifacts 422A and 422B in database 426. In the non-limiting example of FIG. 4, custom generated URL link of artifact 1 428 and custom generated URL link of artifact 2 430 are included in an artifact table 432 stored in database 426. Process flows from operation 408 to operation 410.

In operation 410 of method for creating non-expiring URLs 400, a response payload that includes the custom generated URL links for the artifacts is sent to user 462. In some embodiments, the response payload is sent to a UI, such as UI 622 of FIG. 6. In the non-limiting example of FIG. 4, the response payload includes custom URL links 428 and 430. In some embodiments, the custom generated URL links for the artifacts are configured to be used in method for accessing artifacts after expiration of a URL 500 (discussed below).

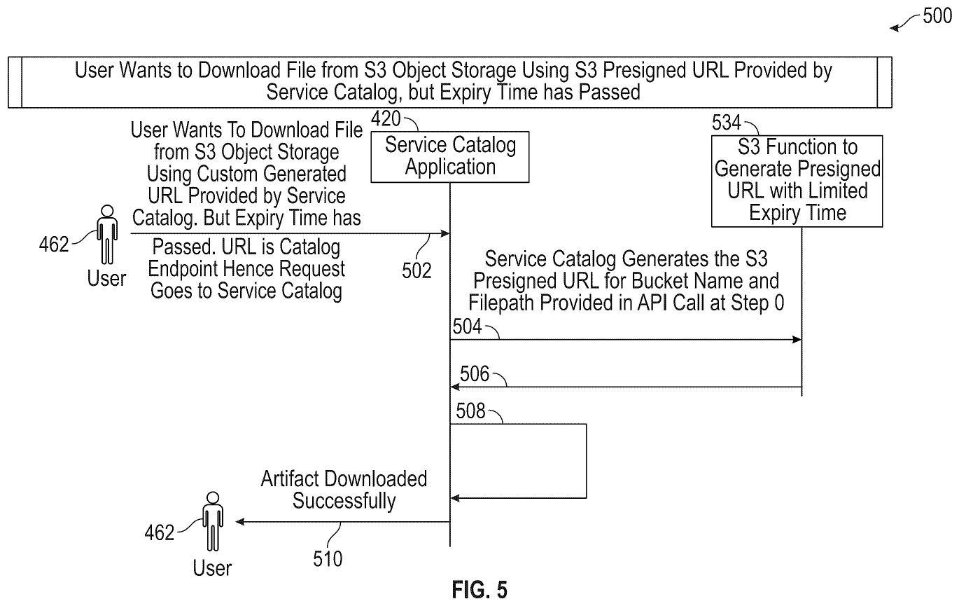

FIG. 5 is a data flow diagram of a method for accessing artifacts after expiration of a URL 500, in accordance with some embodiments.

FIG. 5 is discussed to provide an understanding of the for accessing artifacts after expiration of a URL 500. In some embodiments, method for accessing artifacts after expiration of a URL 500 is executed by processing circuitry 602 discussed below with respect to FIG. 6. In some embodiments, some, or all the operations of method for accessing artifacts after expiration of a URL 500 are executed in accordance with instructions corresponding to instructions 606 discussed below with respect to FIG. 6.

Method for accessing artifacts after expiration of a URL 500 includes operations 502-510, but the operations are not necessarily performed in the order shown. Operations are added, replaced, order changed, and/or eliminated as appropriate, in accordance with the spirit and scope of the embodiments. In some embodiments, one or more of the operations of method for accessing artifacts after expiration of a URL 500 are repeated. In some embodiments, unless specifically stated otherwise, the operations of method for accessing artifacts after expiration of a URL 500 are performed in order.

In operation 502 of method for accessing artifacts after expiration of a URL 500, service catalog application 420 receives a request from user 462 to download one or more files from S3 object storage 424 after the URL expiration time has passed using one or more custom generated URLs generated by service catalog application 420. Process flows from operation 502 to operation 504.

In operation 504 of method for accessing artifacts after expiration of a URL 500, service catalog application 420 generates a presigned URL or the bucket name and file path provided in operation 502. Process flows from operation 504 to operation 506.

In operation 506 of method for accessing artifacts after expiration of a URL 500, service catalog 420 receives the one or more presigned URLs with expiration times from S3 function 534. Process flows from operation 506 to operation 508.

In operation 508 of method for accessing artifacts after expiration of a URL 500, service catalog application 420 redirects the API (the call to the one or more custom generated URLs) and sends a redirect response which user 462 uses to download the one or more presigned URLs generated by service catalog application 420. Process flows from operation 508 to operation 510.

In operation 510 of method for accessing artifacts after expiration of a URL 500, service catalog application 420 sends one or more requested artifacts from operation 502 to user 462 based on the one or more custom generated URLs which are redirected, by the API, to the one or more newly created presigned URLs.

FIG. 6 is a block diagram of processing circuitry 600 to create non-expiring URLs in accordance with some embodiments. In some embodiments, processing circuitry 600 to create non-expiring URLs is a general-purpose computing device including a hardware processor 602 and a non-transitory, computer-readable storage medium 604. Storage medium 604, amongst other things, is encoded with, i.e., stores, computer program code 606, i.e., a set of executable instructions such as an algorithm, or methods 300, 400 and 500. Execution of instructions 606 by hardware processor 602 represents (at least in part) a method to create non-expiring URLs for S3 storage solutions which implements a portion, or all the methods described herein in accordance with one or more embodiments (hereinafter, the noted processes and/or methods).

Processor 602 is electrically coupled to a computer-readable storage medium 604 via a bus 608. Processor 602 is further electrically coupled to an I/O interface 610 by bus 608. A network interface 612 is further electrically connected to processor 602 via bus 608. Network interface 612 is connected to a network 614, so that processor 602 and computer-readable storage medium 604 connect to external elements via network 614. Processor 602 is configured to execute computer program code 606 encoded in computer-readable storage medium 604 to cause processing circuitry 600 to create non-expiring URLs to be usable for performing a portion or all the noted processes and/or methods. In one or more embodiments, processor 602 is a central processing unit (CPU), a multi-processor, a distributed processing system, an application specific integrated circuit (ASIC), and/or a suitable processing unit.

In one or more embodiments, computer-readable storage medium 604 is an electronic, magnetic, optical, electromagnetic, infrared, and/or a semiconductor system (or apparatus or device). For example, computer-readable storage medium 604 includes a semiconductor or solid-state memory, a magnetic tape, a removable computer diskette, a random-access memory (RAM), a read-only memory (ROM), a rigid magnetic disk, and/or an optical disk. In one or more embodiments using optical disks, computer-readable storage medium 604 includes a compact disk-read only memory (CD-ROM), a compact disk-read/write (CD-R/W), and/or a digital video disc (DVD).

In one or more embodiments, storage medium 604 stores computer program code 606 configured to cause processing circuitry 600 to create non-expiring URLs to be usable for performing a portion or all the noted processes and/or methods. In one or more embodiments, storage medium 604 further stores information, such as an algorithm which facilitates performing a portion or all the noted processes and/or methods.

Processing circuitry 600 to create non-expiring URLs includes I/O interface 610. I/O interface 610 is coupled to external circuitry. In one or more embodiments, I/O interface 610 includes a keyboard, keypad, mouse, trackball, trackpad, touchscreen, and/or cursor direction keys for communicating information and commands to processor 602.

Processing circuitry 600 to create non-expiring URLs further includes network interface 612 coupled to processor 602. Network interface 612 allows processing circuitry 600 to create non-expiring URLs to communicate with network 614, to which one or more other computer systems are connected. Network interface 612 includes wireless network interfaces such as BLUETOOTH, WIFI, WIMAX, GPRS, or WCDMA; or wired network interfaces such as ETHERNET, USB, or IEEE-864. In one or more embodiments, a portion or all noted processes and/or methods, is implemented in two or more processing circuitry 600 to create non-expiring URLs.

Processing circuitry 600 to create non-expiring URLs is configured to receive information through I/O interface 610. The information received through I/O interface 610 includes one or more of instructions, data, design rules, and/or other parameters for processing by processor 602. The information is transferred to processor 602 via bus 608. processing circuitry 600 to create non-expiring URLs is configured to receive information related to UI 622 through I/O interface 610. The information is stored in computer-readable medium 604 as user interface (UI) 622.

In some embodiments, a portion or all the noted processes and/or methods is implemented as a standalone software application for execution by a processor. In some embodiments, a portion or all the noted processes and/or methods is implemented as a software application that is a part of an additional software application. In some embodiments, a portion or all the noted processes and/or methods is implemented as a plug-in to a software application.

In some embodiments, a method for creating non-expiring uniform resource locators (URLs), includes receiving, at a service catalog application, one or more registration POST application programming interface (API) calls; processing, by the service catalog application, each payload included with one or more registrations included in the POST API calls; storing, by the service catalog application, one or more artifacts corresponding to the one or more registrations to an object storage; generating, by the service catalog application, one or more custom URLs corresponding to an artifact bucket and an artifact file path; registering, by the service catalog application, the one or more custom URLs with a database; and sending, by the service catalog application, a response payload that includes the one or more custom URLs to a user.

In some embodiments, the one or more registration POST API calls is one or more of a bundle; a template; or a descriptor.

In some embodiments, a custom URL is a custom catalog API.

In some embodiments, the method further includes receiving, by the service catalog application, a request to download an artifact from the object storage where the artifact corresponds to an expired presigned URL, including receiving, by the service catalog application, a custom URL previously created where the custom URL is a catalog endpoint.

In some embodiments, the method further includes generating, by the service catalog application, an presigned URL corresponding to a bucket name and file path included in the catalog endpoint; and sending, by the service catalog application, the presigned URL to a function.

In some embodiments, the method further includes receiving, by the service catalog application, the presigned URL with an expiration time from the function.

In some embodiments, the method further includes redirecting, by the service catalog application, a custom catalog API to call the presigned URL based upon the custom URL previously created.

In some embodiments, the method further includes sending, by the service catalog application, a redirect response that allows the user to download the artifact from the object storage.

In some embodiments, an apparatus, includes a processor; and a memory having instructions stored thereon that, in response to being executed by the processor, cause the processor to receive, at a service catalog application, one or more registration POST application programming interface (API) calls; process, by the service catalog application, each payload included with one or more registrations included in the POST API calls; store, by the service catalog application, one or more artifacts corresponding to the one or more registrations to an object storage; generate, by the service catalog application, one or more custom URLs corresponding to an artifact bucket and an artifact file path; register, by the service catalog application, the one or more custom URLs with a database; and send, by the service catalog application, a response payload that includes the one or more custom URLs to a user.

In some embodiments, the one or more registration POST application programming interface (API) calls is one or more of: a bundle; a template; or a descriptor.

In some embodiments, a custom URL is a custom catalog API.

In some embodiments, the instructions in response to being executed by the processor, further cause the processor to receive, by the service catalog application, a request to download an artifact from the object storage where the artifact corresponds to an expired presigned URL, including receive, by the service catalog application, a custom URL previously created where the custom URL is a catalog endpoint.

In some embodiments, the instructions in response to being executed by the processor, further cause the processor to generate, by the service catalog application, an presigned URL corresponding to a bucket name and file path included in the catalog endpoint; and send, by the service catalog application, the presigned URL to a function.

In some embodiments, the instructions in response to being executed by the processor, further cause the processor to receive, by the service catalog application, the presigned URL with an expiration time from the function.

In some embodiments, the instructions in response to being executed by the processor, further cause the processor to redirect, by the service catalog application, a custom catalog API to call the presigned URL based upon the custom URL previously created.

In some embodiments, the instructions in response to being executed by the processor, further cause the processor to send, by the service catalog application, a redirect response that allows the user to download the artifact from the object storage.

In some embodiments, a non-transitory computer readable medium having instructions stored thereon that, in response to being executed by a processor, cause the processor to receive, at a service catalog application, one or more registration POST application programming interface (API) calls; process, by the service catalog application, each payload included with one or more registrations included in the POST API calls; store, by the service catalog application, one or more artifacts corresponding to the one or more registrations to an object storage; generate, by the service catalog application, one or more custom URLs corresponding to an artifact bucket and an artifact file path; register, by the service catalog application, the one or more custom URLs with a database; and send, by the service catalog application, a response payload that includes the one or more custom URLs to a user.

In some embodiments, the instructions in response to being executed by the processor, further cause the processor to receive, by the service catalog application, a request to download an artifact from the object storage where the artifact corresponds to an expired presigned URL, including receive, by the service catalog application, a custom URL previously created where the custom URL is a catalog endpoint.

In some embodiments, the instructions in response to being executed by the processor, further cause the processor to generate, by the service catalog application, an presigned URL corresponding to a bucket name and file path included in the catalog endpoint; and send, by the service catalog application, the presigned URL to a function.

In some embodiments, the instructions in response to being executed by the processor, further cause the processor to receive, by the service catalog application, the presigned URL with an expiration time from the function.

The foregoing outlines features of several embodiments so that those skilled in the art better understand the aspects of the present disclosure. Those skilled in the art should appreciate that they readily use the present disclosure as a basis for designing or modifying other processes and structures for conducting the same purposes and/or achieving the same advantages of the embodiments introduced herein. Those skilled in the art should further realize that such equivalent constructions do not depart from the spirit and scope of the present disclosure, and that they make various changes, substitutions, and alterations herein without departing from the spirit and scope of the present disclosure.

What is claimed is:

1. A method for creating non-expiring uniform resource locators (URLs), comprising:
receiving, at a service catalog application, one or more registration POST application programming interface (API) calls;
processing, by the service catalog application, each payload included with one or more registrations included in the POST API calls;
storing, by the service catalog application, one or more artifacts corresponding to the one or more registrations to an object storage;
generating, by the service catalog application, one or more custom URLs corresponding to an artifact bucket and an artifact file path;
registering, by the service catalog application, the one or more custom URLs with a database; and
sending, by the service catalog application, a response payload that includes the one or more custom URLs to a user.

2. The method of claim 1, wherein:
the one or more registration POST API calls is one or more of:
a bundle;
a template; or
a descriptor.

3. The method of claim 1, wherein:
a custom URL is a custom catalog API.

4. The method of claim 1, further comprising:
receiving, by the service catalog application, a request to download an artifact from the object storage where the artifact corresponds to an expired presigned URL, comprising:
receiving, by the service catalog application, a custom URL previously created where the custom URL is a catalog endpoint.

5. The method of claim 4, further comprising:
generating, by the service catalog application, an presigned URL corresponding to a bucket name and file path included in the catalog endpoint; and
sending, by the service catalog application, the presigned URL to a function.

6. The method of claim 5, further comprising:
receiving, by the service catalog application, the presigned URL with an expiration time from the function.

7. The method of claim 6, further comprising:
redirecting, by the service catalog application, a custom catalog API to call the presigned URL based upon the custom URL previously created.

8. The method of claim 7, further comprising:
sending, by the service catalog application, a redirect response that allows the user to download the artifact from the object storage.

9. An apparatus, comprising:
a processor; and
a memory having instructions stored thereon that, in response to being executed by the processor, cause the processor to:
receive, at a service catalog application, one or more registration POST application programming interface (API) calls;
process, by the service catalog application, each payload included with one or more registrations included in the POST API calls;
store, by the service catalog application, one or more artifacts corresponding to the one or more registrations to an object storage;
generate, by the service catalog application, one or more custom URLs corresponding to an artifact bucket and an artifact file path;
register, by the service catalog application, the one or more custom URLs with a database; and
send, by the service catalog application, a response payload that includes the one or more custom URLs to a user.

10. The apparatus of claim 9, wherein:
the one or more registration POST application programming interface (API) calls is one or more of:
a bundle;
a template; or
a descriptor.

11. The apparatus of claim 9, wherein:
a custom URL is a custom catalog API.

12. The apparatus of claim 9, wherein the instructions in response to being executed by the processor, further cause the processor to:
receive, by the service catalog application, a request to download an artifact from the object storage where the artifact corresponds to an expired presigned URL, comprising:
receive, by the service catalog application, a custom URL previously created where the custom URL is a catalog endpoint.

13. The apparatus of claim 12, wherein the instructions in response to being executed by the processor, further cause the processor to:
generate, by the service catalog application, an presigned URL corresponding to a bucket name and file path included in the catalog endpoint; and
send, by the service catalog application, the presigned URL to a function.

14. The apparatus of claim 13, wherein the instructions in response to being executed by the processor, further cause the processor to:
receive, by the service catalog application, the presigned URL with an expiration time from the function.

15. The apparatus of claim 14, wherein the instructions in response to being executed by the processor, further cause the processor to:
redirect, by the service catalog application, a custom catalog API to call the presigned URL based upon the custom URL previously created.

16. The apparatus of claim 15, wherein the instructions in response to being executed by the processor, further cause the processor to:
send, by the service catalog application, a redirect response that allows the user to download the artifact from the object storage.

17. A non-transitory computer readable medium having instructions stored thereon that, in response to being executed by a processor, cause the processor to:
receive, at a service catalog application, one or more registration POST application programming interface (API) calls;
process, by the service catalog application, each payload included with one or more registrations included in the POST API calls;
store, by the service catalog application, one or more artifacts corresponding to the one or more registrations to an object storage;
generate, by the service catalog application, one or more custom URLs corresponding to an artifact bucket and an artifact file path;
register, by the service catalog application, the one or more custom URLs with a database; and
send, by the service catalog application, a response payload that includes the one or more custom URLs to a user.

18. The non-transitory computer readable medium of claim 17, wherein the instructions in response to being executed by the processor, further cause the processor to:
receive, by the service catalog application, a request to download an artifact from the object storage where the artifact corresponds to an expired presigned URL, comprising:
receive, by the service catalog application, a custom URL previously created where the custom URL is a catalog endpoint.

19. The non-transitory computer readable medium of claim 18, wherein the instructions in response to being executed by the processor, further cause the processor to:
generate, by the service catalog application, an presigned URL corresponding to a bucket name and file path included in the catalog endpoint; and
send, by the service catalog application, the presigned URL to a function.

20. The non-transitory computer readable medium of claim 19, wherein the instructions in response to being executed by the processor, further cause the processor to:
receive, by the service catalog application, the presigned URL with an expiration time from the function.
